(19) United States
(12) Patent Application Publication
(10) Pub. No.: US 2004/0244904 A1
(43) Pub. Date: Dec. 9, 2004

(54) Combination closure and tear tape packaging materials containing it, and method of using it to seal and later open packages

(76) Inventors: Werner Kluge-Paletta, Buchholz (DE); Gaelle De Roton, Hamburg (DE); Eric Su, Charlotte, NC (US)

Correspondence Address: NORRIS, MCLAUGHLIN & MARCUS, PA, 875 THIRD STREET, 18TH FLOOR, NEW YORK, NY, 10022, US

(21) Appl. No.: 10/480,889

(22) PCT Filed: May 15, 2002
(86) PCT No.: PCT/EP02/05343

Related U.S. Application Data
(60) Provisional application No. 60/297,956, filed on Jun. 13, 2001.

(51) Int. Cl. B32B 31/00; C09J 1/00

(52) U.S. Cl. 156/247; 428/343

(57) ABSTRACT

The specification and drawings describe and show embodiments of the present invention in the form of a combination closure tape and tear strip, an object comprising the combination closure tape and tear strip, and a method of sealing and later opening said object utilizing the combination closure tape and tear strip. It is emphasized that this abstract is provided to comply with the rules requiring an abstract which will allow a searcher or other reader to ascertain quickly the subject matter of the technical disclosure. It is submitted with the understanding that it will not be used to interpret or limit the scope or meaning of the claims.

### BACKGROUND OF THE INVENTION

1. Field of the Invention

The present invention relates to an adhesive tape capable of both sealing and opening objects, for example, packages, such as envelopes and boxes.

2. Description of Related Art

It is known to seal and later open objects, for example envelopes and boxes, using closure tapes to seal the object, and separate tear tapes to open the object later. The manufacture of such objects entails two separate steps, one to place the closure tape, and a second to place the tear strip.

Adhesive tapes which are purportedly useful both to seal and later to open objects are known from U.S. Pat. No. 5,683,029. The invention described therein involves the use of a single piece of double-sided adhesive tape to perform both sealing and opening functions. In practice, however, the opening functions have not always been successfully carried out and the object often fails to open.

### SUMMARY OF THE INVENTION

The present invention relates in a first embodiment to an adhesive tape comprising:

a) a double-sided adhesive closure tape comprising a first backing and pressure-sensitive adhesive applied to both sides of said first backing; and

b) a tear strip laminated onto one side of said double-sided adhesive closure tape, said tear strip comprising a second backing and pressure-sensitive adhesive applied to one side of said second backing.

The present invention relates in a second embodiment to an object comprising an adhesive tape according to the present invention.

The present invention relates in a third embodiment to a method of sealing and later opening the object comprising:

a) providing an object with an adhesive tape according to the present invention;

b) pressing on at least the double-sided adhesive closure tape to seal the object; and

c) pulling on at least the tear strip to open the object.

### BRIEF DESCRITION OF THE DRAWINGS

In the drawings, which illustrate selected embodiments of the present invention:

FIG. 1 is a bottom view of an adhesive tape according to the present invention.

FIG. 2 is a cross-section view of the adhesive tape shown in FIG. 1.

FIG. 3 is a drawing depicting an envelope including the adhesive tape shown in FIG. 1.

FIG. 4 is a drawing depicting a box including the adhesive tape shown in FIG. 1.

### DETAILED DESCRIPTION OF DEPICTED EMBODIMENTS OF THE PRESENT INVENTION

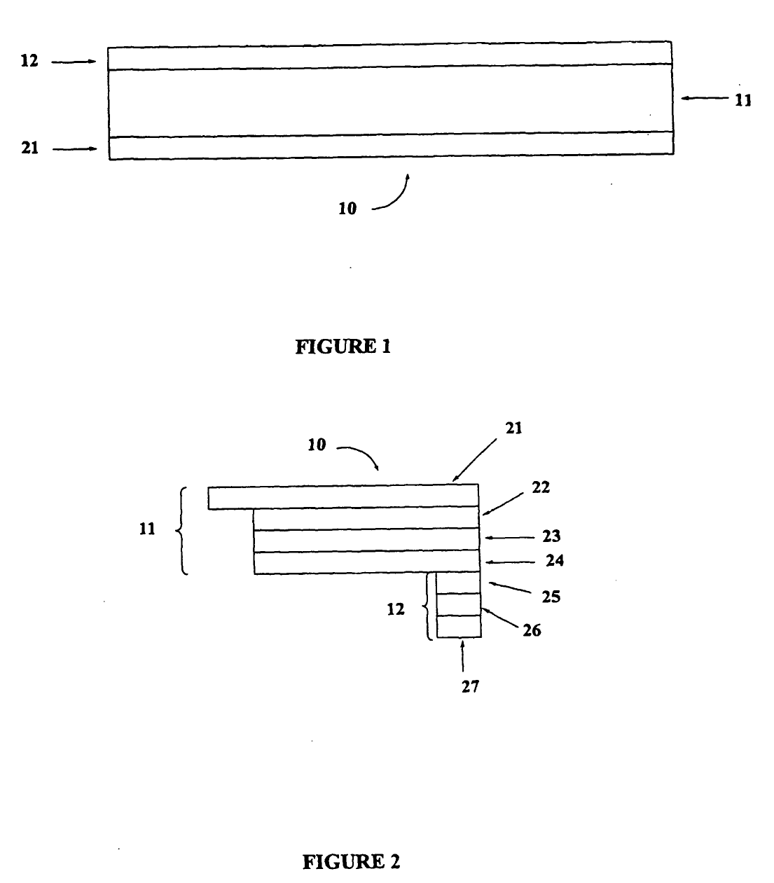

Referring now to the embodiments shown in the drawings, FIG. 1 depicts one possible construction of an adhesive tape according to the present invention. In this particular embodiment, adhesive tape 10 is made up of tear strip 12 laminated onto one side of closure tape 11. As depicted, tear strip 12 is aligned along one edge of closure tape 11. Other constructions are, however, possible, and would readily occur to persons skilled in the art. Optionally, a release liner 21 is adhered to the side of closure tape 11 opposite tear strip 12.

One possible construction of the embodiment shown in FIG. 1 is shown in greater detail in FIG. 2. It should be clear from FIG. 2 that the adhesive tape shown in FIG. 1 consists of a plurality of distinct layers. According to the construction shown in FIG. 2, the closure tape 11 comprises a backing layer 23 having pressure-sensitive adhesive layers 22 and 24 applied to both sides. Optionally, one of the pressure-sensitive adhesive layers, in this case pressure-sensitive adhesive layer 22, has a release liner 21 adhered thereto. The tear strip 12 comprises a backing layer 26 and a pressure-sensitive adhesive layer 27 adhered thereto. Optionally, backing layer 26 is treated on the side facing pressure-sensitive adhesive layer 24 with a release coating 25. Such treatment will facilitate the separation of the tear strip from the closure tape during the opening process. According to this particular construction, tear strip 12 is laminated to closure tape 11. In addition to the layers depicted in FIG. 2, it is possible to include additional layers as desired.

FIG. 2 depicts a special, but optional, feature of the present invention. As depicted, the width of release liner 21 is greater than that of the rest of closure tape 11. The extended portion of release liner 21 provides a so-called “finger lift,” which can make it easier for consumers to remove the release liner and expose the sticky surface of the closure tape. The extended portion of the release liner 21 can be provided on either or both sides of the tape to provide a “right finger lift,” a “left finger lift” or “a right and left finger lift” as desired.

The use of a release liner permits the adhesive tape to be rolled into rolls, which are convenient for use. Given the generally narrow width of the adhesive tapes, it is possible to “spool,” or traverse-wind, a number of rolls of adhesive tape one on top of another, which can help to reduce the number of roll changeover operations. The length of a spooled roll can equal the length of any number of individual, or “pancake,” rolls. For example, a spooled roll can contain generally 60-100 pancake rolls.

Pressure-sensitive adhesive compositions are well known in the art (see, for example, Samuel C. Temin, “pressure-Sensitive Adhesives for Tapes and Labels,” in Handbook of Adhesives, Third Edition, Edited by Ining Skeist, Chapman & Hall, New York, 1990, pages 641-663), and the selection thereof for pressure-sensitive adhesive layers 22, 24 and 27 is not critical. The adhesive compositions of all three layers can be the same or different as desired. Suitable pressure-sensitive adhesives include, merely for example, acrylic pressure-sensitive adhesives, natural rubber pressure-sensitive adhesives, synthetic rubber pressure-sensitive adhesives, polyurethane pressure-sensitive adhesives, and ethylenelvinyl acetate pressure-sensitive adhesives. Pressure-sensitive adhesives applied “on site,” such as hot melt coatings or water-based coatings applied to the backings on the process machine, are also included.

Backings for adhesive closure tapes and tear strips are also well known in the art, and the selection thereof also is not critical so long as the closure and tear functions, respectfully, can be successfully carried out. Especially, the tear strip backing should be selected so that it is capable of actually tearing the package to which the adhesive tape is applied. Perforating the package at appropriate points to serve as a tearing aid can help to facilitate opening and, also, to reduce the strength required of the tear strip backing. To initiate the opening of the package, it is not necessary to perforate along the entire length of the tear strip, but, as is well known in the ant, in the vicinity of one or both ends of the tear strips. Also, the tear strength of the tear strip can be adjusted as desired by varying the width of the tear strip used. For example, the width of the tear strip could be 4 mm for box opening and 3 mm for envelope opening.

Backings for adhesive closure tapes and tear strips can be selected from paper, films, fabrics and foils, reinforced or not as needed, so long as, again, the closure and tear functions, respectfully, can be successfully carried out. The suitable substrates for backings for adhesive closure tapes include polyethylene, polypropylene and other film backings. The suitable substrates for tear strips include tensilized polypropylene or other high strength films, filaments, string and metallic strips. Backings for adhesive closure tapes and tear strips can be colored as desired.

The pressure-sensitive adhesive compositions can be applied to the backings in any of a number of known methods. For example, the pressure-sensitive adhesive compositions can be coated onto the backings or, if the bottom layer is pressure-sensitive adhesive, onto the release liner from a solution. It is also possible to apply the pressure-sensitive adhesive composition as a hot melt using either a hot melt coater, a calendar, or an extruder.

The thickness of the various layers can be varied to a great extent depending on the materials utilized. In general, the thickness of the closure tape ranges from 30 to 300 microns, and the thickness of the tear strip ranges from 30 to 250 microns, as desired.

In similar manner, the widths of the components of the adhesive tape can also be varied as desired. In general, the width of the closure tape ranges from 8 to 50 millimeters, and the width of the tear strip ranges from 2 to 5 millimeters, again, as desired.

For the release liner and release coating, suitable materials are well known in the art and the choice thereof is not critical. The release liner is coated with a material to which the pressure-sensitive adhesive composition adheres poorly. Likewise, the release coating has the same properties. Suitable materials include silicone release coating or non-silicone release coatings, such as waxes, soaps and any other suitable materials well known in the art.

In operation of the embodiment described above, the adhesive tape can be applied to objects of all types, for example, packages, such as envelopes and boxes, to provide a more efficient and reliable means of closing and later opening such objects. The present invention includes both unsealed and sealed objects, for example, unsealed and sealed packages, such as unsealed and sealed envelopes and boxes.

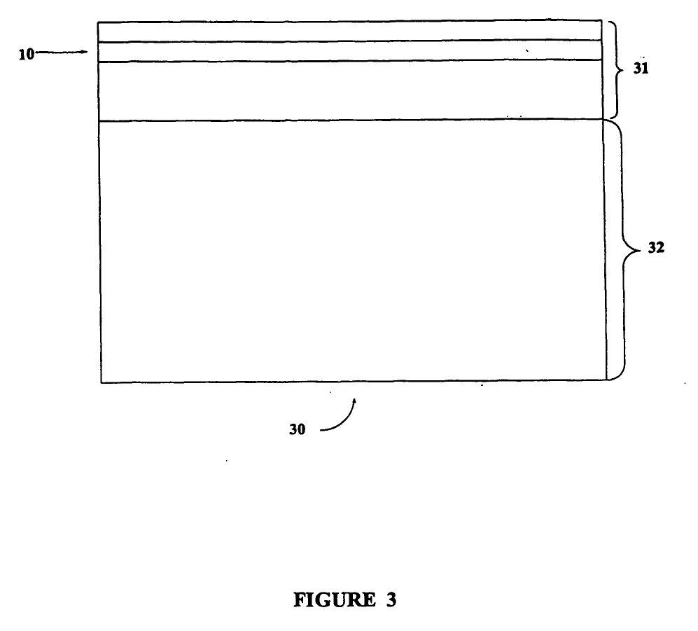

In one embodiment, which is depicted in FIG. 3, envelope 30 comprising a flap portion 31 and a container portion 32 also comprises adhesive tape 10 applied strategically across a portion of flap portion 31 deemed best to provide good closure and reliable opening. As alluded to previously, flap portion 31 may be perforated along either or both sides of adhesive tape 10 along the entire length or a portion thereof to facilitate later opening of the sealed envelope, and, in general, it is best that the length of the adhesive tape 10 is less than that of the package to which it is applied.

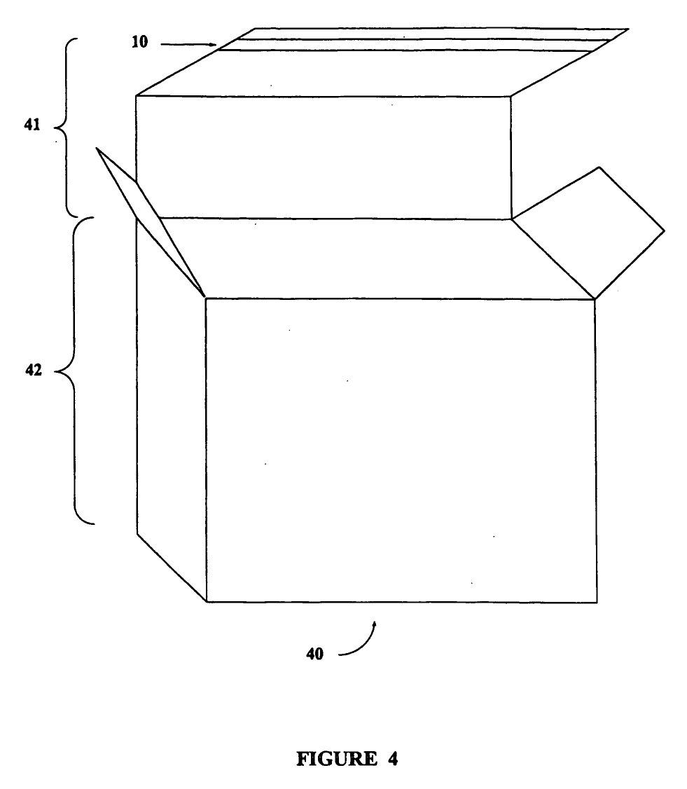

In another embodiment, which is depicted in FIG. 4, box 40 comprising a flap portion 41 and a container portion 42 also comprises adhesive tape 10 applied across a portion of flap portion 41. Again, flap portion 41 may be perforated along either or both sides of adhesive tape 10 along the entire length or a portion thereof to facilitate later opening of the sealed envelope, and, again, it is best that the length of the adhesive tape 10 is less than that of the package to which it is applied.

In addition to boxes and envelopes, the adhesive tape can also be applied to other objects and packages, for example, security packages, temporary joints, and the like.

The use of combination closure and tear tapes as described herein has the advantage of greatly facilitating the processes of manufacturing and using objects containing such tapes. In the prior art, where separate closure and tear tapes have been routinely applied, it has been necessary to apply such tapes separately to the objects intended to contain them. Also, it has been necessary to purchase and keep in inventory two separate tapes. Accordingly, the use of combination closure and tear tapes as described herein greatly simplifies the manufacturing process of such objects.

Also, in the prior art, where objects have been adapted so that the closure tape serves both functions of sealing the object and later opening it, such tapes have often failed so that the object can no longer be opened by pulling on the tapes. Accordingly, the use of combination closure and tear tapes as described herein provides at the same time a means of sealing the objects and a reliable means for later opening it.

The embodiment described above can be explained in even greater detail with reference to the following example.

### EXAMPLE

An adhesive tape according to the present invention is constructed and employed as follows:

The tear strip has a strong film carrier, one side of the film is coated with pressure-sensitive adhesive and the other side of the film can be coated with silicone or non-silicone release material. The tear strip tape is wound onto its own backing, such as tesa 7496 tape, which is ⅛″ in width, which contains a tensilized polypropylene backing, has synthetic rubber pressure-sensitive adhesive applied to one side thereof, and is available from tesa tape inc. of Charlotte, N.C.

The double-sided closure tape has a film carrier; both sides of the film are coated with pressure-sensitive adhesive. The closure tape has a release liner, such as the tape given the internal designation “SR1,” which contains a polyester backing coated on both sides with a synthetic rubber pressure-sensitive adhesive, and is ¾″ in width.

The tear strip is laminated onto the closure tape. The adhesive side of the tear strip is facing up and the release side of the tear tape is facing down. The release side of the tear strip is bonded to the adhesive side of the closure tape at the bottom. Then the combination tape is wound onto its liner. (The liner could be 1″ in width in order to provide ¼″ finger lift.)

This combination tape, designated as SR1/7496, can then be applied onto the upper flap of the boxes or envelopes (the adhesive sides of closure tape, SR1, and tear strip, 7496, are bonded onto this upper flap of the box). The tear strip should align with the perforations on the box for initiation of the opening later. It is better that the SR1/7496 does not extend all the way to the edges of the flap but leaves −¼″ blanks (not covered with SR1/7496 tape) on both sides of the flap.

During the closure operations, the release liner is removed; the other adhesive sides of SR1 are exposed, and bonded onto the container portion of the box to complete the closure.

During the opening, the tearing is initiated by the perforated portion of the upper flap (to which the tear strip, 7496, is bonded) and continued by this strong tear strip. The tear strip is able to break away from the closure tape, SR1, easily because of the release coating on the other side of the tear tape, 7496. After the tear strip is removed the opening operation is then completed.

It should be understood that the preceding is merely a detailed description of the depicted embodiments of this invention and that numerous changes to the depicted embodiments can be made in accordance with the disclosure herein without departing from the spirit or scope of the invention. The preceding description, therefore, is not meant to limit the scope of the invention. Rather, the scope of the invention is to be determined only by the appended claims and their equivalents.

1. An adhesive tape comprising:
a) a double-sided adhesive closure tape comprising a first backing and pressure-sensitive adhesive applied to both sides of said first backing; and
b) a tear strip laminated onto one side of said double-sided adhesive closure tape, said tear strip comprising a second backing and pressure-sensitive adhesive applied to one side of said second backing.

2. The adhesive tape according to claim 1, which further comprise a release liner applied to an outer side of said double-sided adhesive closure tape.

3. The adhesive tape according to claim 2, wherein the width of the release liner is greater than the width of the double sided-adhesive closure tape so that the release liner protrudes from at leas tone edge of said double-sided adhesive closure tape.

4. The adhesive tape according to claim 1, wherein said first backing is a film backing.

5. The adhesive tape according to claim 1, wherein said second backing is a film backing.

6. The adhesive tape according to claim 1, wherein the tear strip is aligned along an edge of the double-sided adhesive closure tape.

7. The adhesive tape according to claim 1, wherein the tear strip is coated on one side with a release material.

8. The adhesive tape according to claim 1, wherein the width of the tear strip is less than the width of the double-sided adhesive closure tape.

9. A roll of adhesive tape according to claim 1.

10. A spool comprising a traverse-wound roll according to claim 9.

11. An envelope comprising an adhesive tape according to claim 1.

12. A box comprising an adhesive tape-according to claim 1.

13. A method of sealing and opening an envelope comprising the following steps:
a) providing an envelope according to claim 11;
b) pressing on at least the double-sided adhesive closure tape to seal the envelope; and
c) pulling on at least the tear strip to open the envelope.

14. A method of sealing and opening a box comprising the following steps:
a) providing a box according to claim 12;
b) pressing on at least the double-sided adhesive closure tape to seal the box; and
c) pulling on at least the tear strip to open the box.
